(19) United States
(12) Patent Application Publication
(10) Pub. No.: US 2017/0058769 A1
(43) Pub. Date: Mar. 2, 2017

(54) SYSTEM AND METHOD FOR OPERATING A DRY LOW NOx COMBUSTOR IN A NON-PREMIX MODE

(71) Applicant: General Electric Company, Schenectady, NY (US)

(72) Inventors: Daniel Doyle Vandale, Greenville, SC (US); Michael Anthony Cocca, Atlanta, GA (US); James Harper, Greenville, SC (US)

(21) Appl. No.: 15/237,676

(22) Filed: Aug. 16, 2016

Related U.S. Application Data
(60) Provisional application No. 62/210,611, filed on Aug. 27, 2015.

(51) Int. Cl. F02C 3/30

(52) U.S. Cl. CPC F02C 3/30

(57) ABSTRACT

A system for operating a combustor in a non-Premix mode of operation includes a combustor comprising a plurality of primary fuel nozzles annularly arranged around a center fuel nozzle, a fuel supply system that is fluidly coupled to the plurality of primary fuel nozzles and the center fuel nozzle, a steam injection system that is fluidly coupled to the fuel supply system and to at least one of the plurality of primary fuel nozzles or the center fuel nozzle and a controller. The controller is electronically coupled to the fuel supply system and the steam injection system. The controller is programmed to initiate the steam injection system to inject a flow of superheated steam into a flow of fuel from the fuel supply system upstream from at least one of the plurality of primary fuel nozzles or the center fuel nozzle during a non-Premix mode of operation of the combustor.

### CROSS REFERENCE TO RELATED APPLICATIONS

The present application claims filing benefit of U.S. Provisional Patent Application Ser. No. 62/210,611 having a filing date of Aug. 27, 2015, which is incorporated by reference herein in its entirety.

### FIELD OF THE INVENTION

The present invention relates to a Dry Low NOx (DLN) type combustor for a gas turbine engine. More particularly, the present invention relates to a system and method for operating a DLN-1 style combustor in a non-premix mode.

### BACKGROUND OF THE INVENTION

A gas turbine generally includes an inlet section, a compressor section, a combustion section, a turbine section and an exhaust section. The inlet section cleans and conditions a working fluid (e.g., air) and supplies the working fluid to the compressor section. The compressor section progressively increases the pressure of the working fluid and supplies a compressed working fluid to multiple annularly arranged combustors of the combustion section. The compressed working fluid and a fuel such as natural gas is mixed and burned within the combustors so as to generate combustion gases at high temperature and pressure. The combustion gases are routed from the combustors into the turbine section where they expand to produce work. For example, expansion of the combustion gases in the turbine section may cause a shaft connected to a generator to rotate, thus producing electricity.

Regulatory requirements for low emissions from gas turbine power plants have continually grown more stringent over the years. Environmental agencies throughout the world are now requiring even lower rates of emissions of oxides of nitrogen (NOx) and other pollutants from both new and existing gas turbines. In order to balance fuel efficiency with emissions requirements, various types of gas turbines utilize a Dry Low NOx (DLN) combustion system. A DLN-1 or DLN-1+ type combustor by General Electric Co. is a two-stage pre-mixed combustor designed for use with natural gas fuel and may be capable of operation on liquid fuel. The DLN-1 or DLN-1+ type combustor provides a fuel injection system including a secondary fuel nozzle positioned on the center axis of the combustor surrounded by a plurality of primary fuel nozzles annularly arranged around the secondary fuel nozzle.

At between about seventy percent of full load to about one hundred percent of full load, the DLN-1 or DLN-1+ type combustor maintains very low exhaust emission levels while maintaining high levels of efficiency using lean premixed fuel/air concepts. The low emissions levels, particularly NOx emissions levels, may be maintained, at least in part, by injecting water or steam into the combustion gases at or downstream from a combustion zone during premix operation of the combustor. However, these methods are generally less effective at addressing emissions levels, particularly NOx emissions levels, generated during primary operation of the DLN-1 or DLN-1+ combustor which occurs between ignition and about thirty five percent load and lean-lean operation which occurs between about thirty five percent and about seventy five percent of load. Accordingly, there is a need to provide a DLN-1 or DLN-1+ combustor with a capability for reduced or low emissions performance during non-premix operation.

### BRIEF DESCRIPTION OF THE INVENTION

Aspects and advantages of the invention are set forth below in the following description, or may be obvious from the description, or may be learned through practice of the invention.

One embodiment of the present invention is a system for operating a combustor in a non-Premix mode of operation. The system includes a combustor comprising a plurality of primary fuel nozzles annularly arranged around a center fuel nozzle, a fuel supply system that is fluidly coupled to the plurality of primary fuel nozzles and the center fuel nozzle, a steam injection system that is fluidly coupled to the fuel supply system and to at least one of the plurality of primary fuel nozzles or the center fuel nozzle and a controller. The controller is electronically coupled to the fuel supply system and the steam injection system. The controller is programmed to initiate the steam injection system to inject a flow of superheated steam into a flow of fuel from the fuel supply system upstream from at least one of the plurality of primary fuel nozzles or the center fuel nozzle during a non-Premix mode of operation of the combustor.

Another embodiment of the present disclosure includes a power plant. The power plant includes a gas turbine having a compressor, a combustor downstream from the compressor and a turbine disposed downstream from the combustor. The combustor comprises a plurality of primary fuel nozzles annularly arranged around a center fuel nozzle. A fuel supply system is fluidly coupled to the plurality of primary fuel nozzles and to the center fuel nozzle. A heat recovery steam generator is disposed downstream from the turbine and a system for operating the combustor in a non-Premix mode of operation is coupled to the combustor. The system includes a steam injection system that is fluidly coupled to the fuel supply system and to at least one of the plurality of primary fuel nozzles or the center fuel nozzle. The power plant further comprises a controller that is electronically coupled to the fuel supply system and the steam injection system. The controller initiates the steam injection system to inject a flow of superheated steam into a flow of fuel from the fuel supply system upstream from at least one of the plurality of primary fuel nozzles or the center fuel nozzle during a non-Premix mode of operation of the combustor.

Another embodiment of the present disclosure includes a method for operating a combustor in a non-Premix mode of operation. The method includes initiating a non-Premix mode of operation for the combustor and injecting superheated steam from a steam injection system into one or more primary fuel nozzles of a plurality of primary fuel nozzles or a center fuel nozzle of the combustor.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine based power plant within the scope of the present invention;

FIG. 2 is a simplified cross sectioned side view of an exemplary Dry Low NOx combustor as may incorporate at least one embodiment of the present invention;

FIG. 3 is a simplified cross sectioned side view of an exemplary Dry Low NOx combustor as may incorporate at least one embodiment of the present invention;

FIG. 4 is a simplified cross sectioned side view of an exemplary Dry Low NOx combustor as may incorporate at least one embodiment of the present invention; and

FIG. 5 is a block diagram of a method for operating a combustor in a non-Premix mode of operation according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

An embodiment of the present invention takes the form of a system and method for injecting superheated steam from a steam injection system into a Dry Low NOx or DLN type combustor such as a DLN-1 and/or a DLN-1+ combustor during a non-Premix mode of operation to reduce NOx emissions levels during non-Premix mode operation of the combustor. Various embodiments of the present invention have the technical effect of broadening the range of combustor operability limits below Premix mode of operation by reducing emissions of oxides of nitrogen “NOx”. The present invention may inject an amount of superheated steam into a gas fuel supply line prior to the gas fuel entering the combustion system upstream from a plurality of primary fuel nozzles and/or a center fuel nozzle of the combustor.

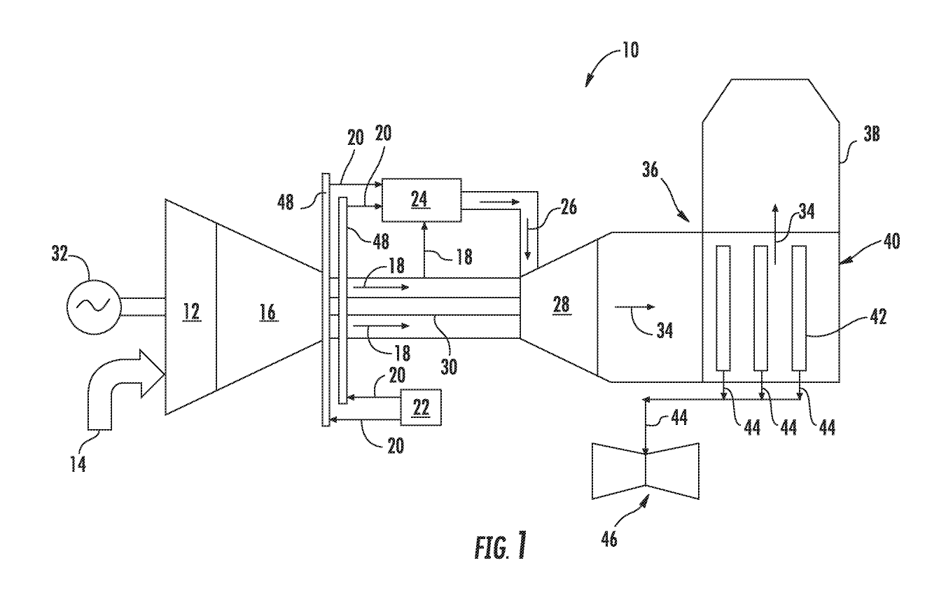

Referring now to the drawings, wherein identical numerals indicate the same elements throughout the figures, FIG. 1 provides a functional block diagram of an exemplary power plant site comprising a gas turbine 10 that may incorporate various embodiments of the present invention. As shown, the gas turbine 10 generally includes an inlet section 12 that may include a series of filters, cooling coils, moisture separators, and/or other devices to purify and otherwise condition air 14 or other working fluid entering the gas turbine 10. The air 14 flows to a compressor section where a compressor 16 progressively imparts kinetic energy to the air 14 to produce compressed air 18.

The compressed air 18 is mixed with a fuel 20 such as natural gas from a fuel supply system 22 to form a combustible mixture within one or more combustors 24. The combustible mixture is burned to produce combustion gases 26 having a high temperature, pressure and velocity. The combustion gases 26 flow through a turbine 28 of a turbine section to produce work. For example, the turbine 28 may be connected to a shaft 30 so that rotation of the turbine 28 drives the compressor 16 to produce the compressed air 18. Alternately or in addition, the shaft 30 may connect the turbine 28 to a generator 32 for producing electricity. Exhaust gases 34 from the turbine 28 flow through an exhaust section 36 that connects the turbine 28 to an exhaust stack 38 downstream from the turbine 28. The exhaust section 36 may include, for example, a heat recovery steam generator (HRSG) 40 for cleaning and extracting additional heat from the exhaust gases 34 prior to release to the environment. For example, the HRSG 40 may include one or more heat exchangers 42 in thermal communication with the exhaust gases 34 and which generate superheated steam as indicated schematically by arrows 44. The superheated steam may then be routed to various components at the power plant site such as to one or more steam turbines 46.

As shown in FIG. 1, the fuel supply system may include various fuel distribution manifolds or rings 48 that are each adapted to receive a fuel from the fuel supply system 22 and to distribute the fuel to various fuel circuits (not shown) defined within each combustor 24. The various fuel circuits may allow for greater fuel control flexibility to one or more fuel nozzles positioned within the combustors. For example, one fuel distribution manifold 48 may provide a portion of fuel 20 to a primary fuel circuit within the combustor 24 while another fuel distribution manifold 48 may provide fuel to a secondary or center fuel circuit within the combustor 24.

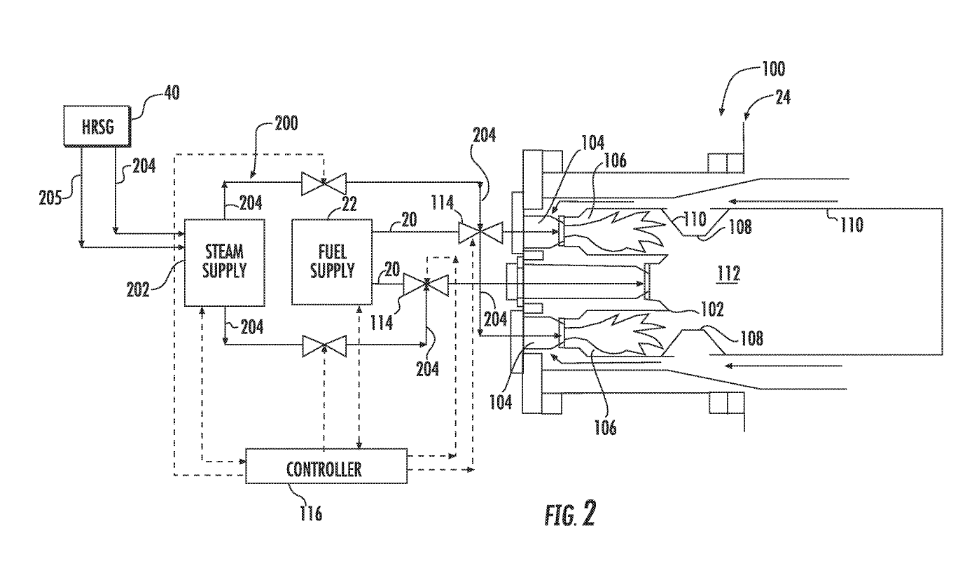

In various embodiments, the combustor 24 is a Dry Low NOx (DLN) type combustor. More particularly, in particular embodiments, the combustor 24 as shown in FIG. 1, is a DLN-1 or a DLN-1+ type combustor as manufactured by the General Electric Company. FIGS. 2, 3 and 4 provide simplified cross sectioned side views of an exemplary DLN type combustor 100 as may incorporate one or more embodiments of the present disclosure. As shown in FIGS. 2, 3 and 4, the DLN combustor 100 includes a secondary or center fuel nozzle 102 and multiple primary or outer fuel nozzles 104 organized annularly around the secondary fuel nozzle 102. Primary combustion zones or mixing chambers 106 are formed downstream from each primary fuel nozzle 104 and upstream from a venturi 108 which is at least partially formed by one or more combustion liners 110. The combustor 100 also includes a secondary or premix combustion zone 112 which is defined downstream from the primary combustion zones 106 and downstream from the center fuel nozzle 102.

The primary fuel nozzles 104 and the center fuel nozzle 102 are in fluid communication with the fuel supply system 22 via various fluid conduits, flow control valves 114 and couplings. As shown in FIGS. 2, 3 and 4, the fuel supply system 22 and/or the valves 114 may be electronically coupled to a controller 116.

The fuel supply system 22 may be configured to provide the same fuel type such as natural gas or liquid fuel to both the primary fuel nozzles 104 and the center fuel nozzle 102. In certain configurations, the fuel supply system 22 may be configured to provide different fuel types such as natural gas and/or a liquid fuel to the primary fuel nozzles 104 and/or the center fuel nozzle 102. The controller 116 may be programmed to direct the fuel supply system 22 to supply fuel 20 to the primary fuel nozzles 104 and the center fuel nozzle 102 at similar flow rates and at different flow rates as the combustor 100 transitions between and/or operates in various modes of operation such as a Primary mode of operation, a Lean-Lean mode of operation, a Secondary mode of operation and a Premix mode of operation.

As illustrated in FIG. 2, during the Primary mode of operation which typically occurs from ignition up to about thirty percent of full load, the controller 116 may direct the fuel supply system 22 to provide one hundred percent of the total fuel flow to the combustor 100 to the primary fuel nozzles 104. As a result, combustion during the Primary mode of operation takes place primarily in the primary combustion zones 106.

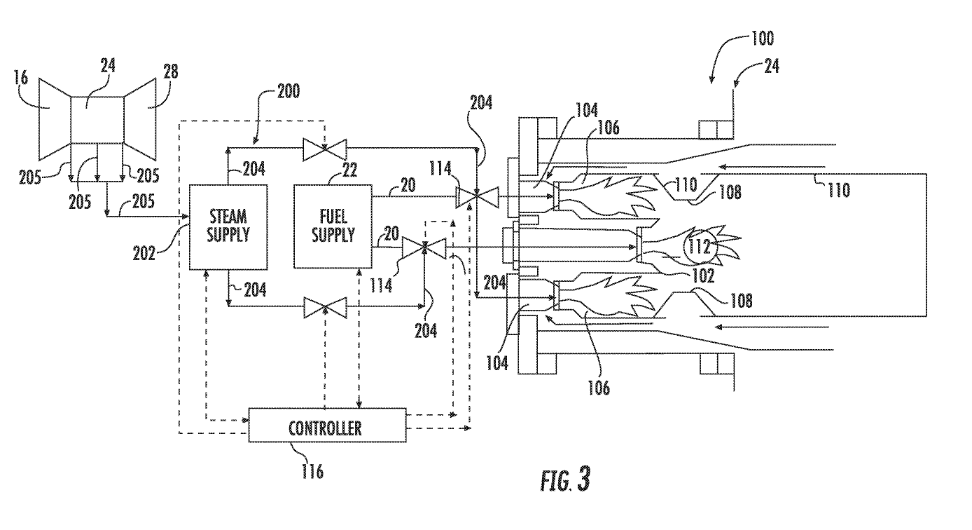

Referring now to FIG. 3, during Lean-Lean mode of operation of the combustor 100 which typically occurs from about thirty percent to about seventy percent of full load, the controller 116 may direct the fuel supply system 22 to split the total fuel flow between the primary fuel nozzles 104 and the center fuel nozzle 102. For example, the controller 116 may direct the fuel supply system 22 to provide about seventy percent of the total fuel flow to the primary fuel nozzles 104 and about thirty percent of the total fuel flow to the center fuel nozzle 102. As a result, combustion during the Lean-Lean mode of operation takes place in both the primary combustion zones 106 as well as the secondary combustion zone 112.

A Secondary mode of operation occurs when the combustor 100 transitions between Lean-Lean mode of operation and a premix mode of operation. During the secondary mode of operation the controller 116 may direct the fuel supply system 22 to decrease the fuel flow to the primary fuel nozzles 104 from about seventy percent to about zero percent of total fuel flow to the combustor 100 while increasing the fuel flow to the center fuel nozzle 102 from about thirty percent to about one hundred percent of the total fuel flow, thus allowing the flames associated with the primary combustion zones 106 to extinguish while maintaining a flame in the secondary combustion zone 112 which originates from the center fuel nozzle 102.

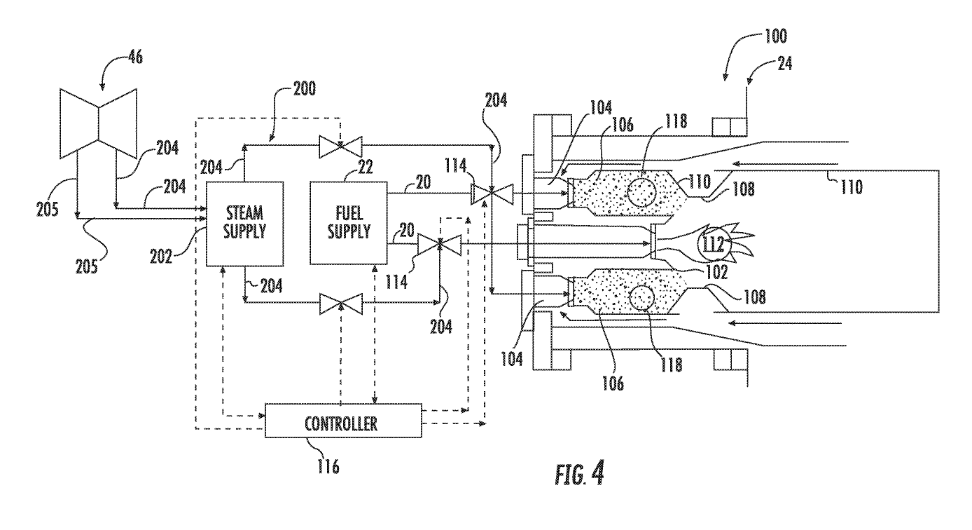

Referring now to FIG. 4, during the Premix mode of operation of the combustor 100, the fuel split between the primary fuel nozzles 104 and the center fuel nozzle 102 may be modified such that the primary fuel nozzles 104 receive about eighty percent of the total fuel flow to the combustor 100 while the center fuel nozzle 102 may receive about twenty percent of the total fuel flow to the combustor 100. The fuel 20 flowing to the primary fuel nozzles 104 is premixed with the compressed air 18 from the compressor 16 (FIG. 1) within the primary combustion zones 106 to form a fuel/air mixture 118 therein.

The premixed fuel/air mixture 118 then flows through the venturi 108 and into the primary combustion zone 112 prior to ignition by the flame from the center fuel nozzle 102. The various fuel splits and percentages of load provided herein with regards to the Primary, Lean-Lean, Secondary and Premix modes of operation are exemplary and not meant to be limiting unless otherwise specified in the claims. For example, other factors such as whether bleed heat from the gas turbine 10 or other source is provided to the combustor 100, fuel properties and combustion hardware may affect the fuel splits and/or the percentage of load as related to the various operating modes.

As used herein, the term “non-premix mode of operation” refers to an operating mode of the combustor 100 that is either the Primary, Lean-Lean or the Secondary operating mode up to the point of transition into the Premix mode of operation. In addition, “non-Premix mode of operation” may include any transient mode of operation which occurs between the Primary, Lean-lean and the Secondary modes of operation.

During Primary operation and/or during Lean-Lean operation of the combustor 100, the combustor 100 may generally operate outside of desired oxides of nitrogen or “NOx” emissions levels. FIGS. 2, 3 and 4, each illustrate a system 200 for operating the DLN type combustor 100 in a non-premix operating mode or condition. In various embodiments, as shown in FIGS. 2, 3 and 4, the system 200 includes a steam injection system or supply 202 for providing superheated steam as indicated schematically by arrows 204 to the primary fuel nozzles 104 and/or to the center fuel nozzle 102 during non-Premix mode of operation of the combustor 100 such as during Primary mode of operation and/or Lean-Lean mode of operation.

In various embodiments, the steam injection system 202 may be electronically coupled to the controller 116. The controller 116 may be programed to actuate various flow control valves 206 that provide for fluid communication between the steam injection system 202 and the primary fuel nozzles 104 and between the steam injection system 202 and the center fuel nozzle 102. The steam injection system 202 may be configured to generate the superheated steam 204 or may be fluidly coupled to an external superheated steam source. For example, the steam injection system 202 may include one or more heat exchangers (not shown) for converting a source of water to superheated steam 204.

In particular embodiments, as shown in FIG. 2, the steam injection system 202 may receive the superheated steam 204 from the HRSG 40 and/or may receive thermal energy from the HRSG 40 via various fluid conduits and/or couplings. In other embodiments, as shown in FIG. 3, the steam injection system 202 may receive thermal energy 205 from an extraction port that is in fluid communication with the compressor 16, a compressor discharge casing that is downstream from the compressor 16 or the turbine 28. In particular embodiments, as shown in FIG. 4, the steam injection system 202 may receive the superheated steam 204 and/or thermal energy from the steam turbine 46 and/or a boiler (not shown).

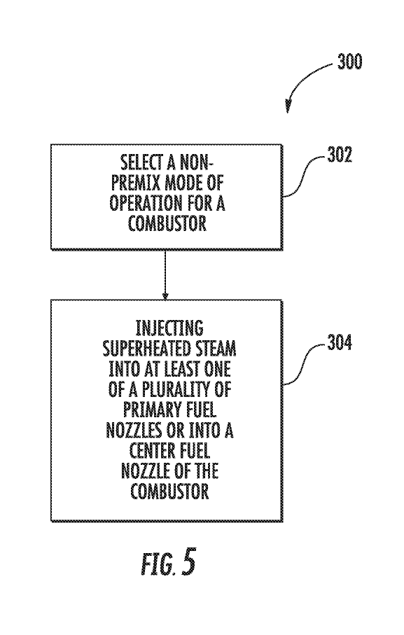

The present invention is described below with reference to FIG. 5 which provides a block diagram of an exemplary method 300 for operating the DLN type combustor 100 in a non-premix mode of operation. As shown in FIG. 5, at step 302 method 300 may include operating the combustor 100 in a non-Premix mode of operation. At step 304 method 300 may include injecting superheated steam 204 into at least one of the primary fuel nozzles 104 or the center fuel nozzle 106 of the combustor 100.

In one embodiment, step 304 may comprise injecting the superheated steam into the primary fuel nozzles 104 only. In one embodiment, step 304 may comprise injecting the superheated steam into the center fuel nozzle 102 only. In one embodiment, step 304 may comprise injecting the superheated steam into both the primary fuel nozzles 104 and the center fuel nozzle 102.

In particular embodiments, the method 300 may include varying a flow rate of the superheated steam 204 to at least one of the primary fuel nozzles 104 or the center fuel nozzle 106. The method 300 may further include varying a flow rate of the superheated steam 204 to the primary fuel nozzles 104 only. The method 300 may further include varying a flow rate of the superheated steam 204 to the center fuel nozzle 106 only.

In particular embodiments, method 300 may include shutting off the flow of the superheated steam prior to initiating the Premix mode of operation. In particular embodiments, method 300 may include deselecting the Premix mode of operation and initiating the flow of the superheated steam 204 via the controller 116 to at least one of the primary fuel nozzles 104 or the center fuel nozzle 106.

It should be noted that, in some alternative implementations, the functions noted in the steps may occur out of the order noted in the figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed:

1. A system for operating a combustor in a non-Premix mode of operation, comprising:
a combustor comprising a plurality of primary fuel nozzles annularly arranged around a center fuel nozzle;
a fuel supply system fluidly coupled to the plurality of primary fuel nozzles and the center fuel nozzle;
a steam injection system fluidly coupled to the fuel supply system and to at least one of the plurality of primary fuel nozzles or the center fuel nozzle; and
a controller electronically coupled to the fuel supply system and the steam injection system, wherein the controller initiates the steam injection system to inject a flow of superheated steam into a flow of fuel from the fuel supply system upstream from at least one of the plurality of primary fuel nozzles or the center fuel nozzle during a non-Premix mode of operation of the combustor.

2. The system as in claim 1, further comprising a compressor of a gas turbine fluidly coupled to the steam injection system, wherein the compressor provides thermal energy to the steam injection system.

3. The system as in claim 1, further comprising a heat recovery steam generator fluidly coupled to the steam injection system, wherein the heat recovery steam generator provides thermal energy to the steam injection system.

4. The system as in claim 1, further comprising a heat recovery steam generator fluidly coupled to the steam injection system, wherein the heat recovery steam generator provides superheated steam to the steam injection system.

5. The system as in claim 1, further comprising a turbine of a gas turbine fluidly coupled to the steam injection system, wherein the turbine provides thermal energy to the steam injection system.

6. The system as in claim 1, further comprising a steam turbine fluidly coupled to the steam injection system, wherein the steam turbine provides thermal energy to the steam injection system.

7. The system as in claim 1, further comprising a steam turbine fluidly coupled to the steam injection system, wherein the steam turbine provides superheated steam to the steam injection system.

8. The system as in claim 1, wherein the combustor further comprises a combustion liner having a venturi and a secondary combustion zone defined by the combustion liner downstream from the venturi.

9. A power plant, comprising:
a gas turbine having a compressor, a combustor downstream from the compressor and a turbine disposed downstream from the combustor, the combustor comprising a plurality of primary fuel nozzles annularly arranged around a center fuel nozzle;
a fuel supply system fluidly coupled to the plurality of primary fuel nozzles and the center fuel nozzle;
a heat recovery steam generator disposed downstream from the turbine; and
a system for operating a combustor in a non-Premix mode of operation, the system comprising:
a steam injection system fluidly coupled to the fuel supply system and to at least one of the plurality of primary fuel nozzles or the center fuel nozzle; and
a controller electronically coupled to the fuel supply system and the steam injection system, wherein the controller initiates the steam injection system to inject a flow of superheated steam into a flow of fuel from the fuel supply system upstream from at least one of the plurality of primary fuel nozzles or the center fuel nozzle during a non-Premix mode of operation of the combustor.

10. The power plant as in claim 9, wherein the compressor is fluidly coupled to the steam injection system, wherein the compressor provides thermal energy to the steam injection system.

11. The power plant as in claim 9, wherein the heat recovery steam generator is fluidly coupled to the steam injection system, wherein the heat recovery steam generator provides thermal energy to the steam injection system.

12. The power plant as in claim 9, wherein the heat recovery steam generator is fluidly coupled to the steam injection system, wherein the heat recovery steam generator provides superheated steam to the steam injection system.

13. The power plant as in claim 9, wherein the turbine is fluidly coupled to the steam injection system, wherein the turbine provides thermal energy to the steam injection system.

14. The power plant as in claim 9, further comprising a steam turbine fluidly coupled to the steam injection system, wherein the steam turbine provides thermal energy to the steam injection system.

15. The power plant as in claim 9, further comprising a steam turbine fluidly coupled to the steam injection system, wherein the steam turbine provides superheated steam to the steam injection system.

16. The power plant as in claim 9, wherein the combustor further comprises a combustion liner having a venturi and a secondary combustion zone defined by the combustion liner downstream from the venturi.

17. A method for operating a combustor in a non-Premix mode of operation, comprising:
initiating a non-Premix mode of operation for the combustor; and
injecting superheated steam from a steam injection system into one or more primary fuel nozzles of a plurality of primary fuel nozzles or a center fuel nozzle of the combustor.

18. The method as in claim 17, wherein the superheated steam is injected into both the plurality of primary fuel nozzles and into the center fuel nozzle.

19. The method as in claim 17, further comprising directing the superheated steam from at least one of a heat recovery steam generator and a steam turbine to the steam injection system.

20. The method as in claim 17, further comprising directing thermal energy from at least one of a compressor, a turbine and a heat recovery steam generator to the steam injection system to produce the superheated steam.
